(19) United States
(12) Patent Application Publication
(10) Pub. No.: US 2008/0224593 A1
(43) Pub. Date: Sep. 18, 2008

(54) Plasma display panel and display device including the same

(76) Inventor: Young-Gil Yoo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/076,193

(22) Filed: Mar. 14, 2008

(30) Foreign Application Priority Data
Mar. 16, 2007 (KR) 10-2007-0026162

(51) Int. Cl. H01J 63/04

(52) U.S. Cl. 313/487

(57) ABSTRACT

A PDP includes first and second substrates, a plurality of electrodes between the first and second substrates, a plurality of barrier ribs between the first and second substrates to define discharge cells, at least one dielectric layer on the electrodes, a protective layer on the dielectric layer, a discharge gas in the discharge cells, and a plurality of photoluminescent layers in the discharge cells, the photoluminescent layers including at least one red photoluminescent layer in a corresponding discharge cell, the red photoluminescent layer including at least one inorganic pigment, and exhibiting a substantially lower decrease in a light emitting peak at about 570 nm to about 600 nm than at about 610 to about 630 nm, as compared to a comparable photoluminescent layer including no inorganic pigment.

### BACKGROUND OF THE INVENTION

1. Field of the Invention

Embodiments of the present invention relate to a plasma display panel (PDP) and to a display device including the same. More particularly, embodiments of the present invention relate to a PDP having improved red color purity.

2. Description of the Related Art

A PDP refers to a display device using a plasma phenomenon, i.e., a gas-discharge phenomenon, to display images. For example, application of a predetermined voltage to electrodes between two substrates may cause excitation of a discharge gas between the electrodes to trigger emission of ultraviolet (UV) light. The UV light may excite photoluminescent layers between the two substrates to emit red, blue, and/or green lights. For example, red light may be emitted from red phosphor layers containing (Y,Gd)BO₃:Eu.

The conventional discharge gas of the PDP may include, e.g., neon gas and xenon gas to decrease a discharge voltage and to stabilize discharge. During excitation, however, the neon gas may emit orange light having a wavelength of about 590 nm, so red color purity may be deteriorated when an image is realized on a screen. Further, the (Y,Gd)BO₃:Eu in the red phosphor layers, despite its high light emission efficiency, high brightness, long life-span, and satisfactory particle shape/diameter, may emit orange light, i.e., a main light emission peak at about 590 nm, so the color purity of a displayed image may be further reduced.

Attempts have been made to mix (Y,Gd)BO₃:Eu with Y(P,V)O₄:Eu to improve color purity and/or to use a neon-cut shield layer to absorb orange light. Use of the Y(P,V)O₄:Eu, however, may cause reduced PDP display characteristics due to poor brightness saturation of the Y(P,V)O₄:Eu, and the neon-cut shield layer may lengthen manufacturing time and procedures and increase costs thereof.

### SUMMARY OF THE INVENTION

Embodiments of the present invention are therefore directed to a PDP and a display device including the same, which substantially overcome one or more of the disadvantages and shortcomings of the related art.

It is therefore a feature of an embodiment of the present invention to provide a PDP with improved red color purity.

It is therefore another feature of an embodiment of the present invention to provide a plasma display device with a PDP having improved red color purity without use of a neon-cut shield layer.

At least one of the above and other features and advantages of the present invention may be realized by providing a PDP, including a first substrate spaced apart from a second substrate by a predetermined distance, a plurality of display electrodes along a first direction between the first and second substrates, a plurality of address electrodes along a second direction between the first and second substrates, the second direction crossing the first direction, a plurality of barrier ribs between the first and second substrates to define discharge cells, at least one dielectric layer between the display and address electrodes, a protective layer on the dielectric layer, a discharge gas in the discharge cells, and a plurality of photoluminescent layers in the discharge cells, the photoluminescent layers including at least one red photoluminescent layer, the red photoluminescent layer including at least one inorganic pigment and exhibiting a substantially larger decrease in a light emitting peak at about 570 nm to about 600 nm than at about 610 to about 630 nm, as compared to a comparable photoluminescent layer including no inorganic pigment. The light emitting peaks at about 570 nm to about 600 nm and at about 610 nm to about 630 nm of the red photoluminescent layer may relate to corresponding light emitting peaks of the comparable photoluminescent layer including no inorganic pigment according to Equation 1 below,

|L_{P}−L_{P+1}|_{570-600 nm}≧2|L_{P}−L_{P+1}|_{610-630 nm} Equation 1

where L_{P} may denote a light emitting peak of the comparable photoluminescent layer without the inorganic pigment, L_{P+1} may denote a light emitting peak of the red photoluminescent layer, and the subscripts 570-600 nm and 610-630 nm may denote wavelength ranges.

The red photoluminescent layer may include at least one of (Y,Gd)BO₃:Eu, YBO₃:Eu, and GdBO₃:Eu. The inorganic pigment may include at least one of Fe₂O₃, CuO, and Cu₂O. The red photoluminescent layer may have a single-layer structure or a multi-layer structure. The red photoluminescent layer may have a multi-layer structure, the multi-layer structure including at least one photoluminescent material layer and at least one inorganic pigment layer on the photoluminescent material layer. The inorganic pigment layer may have a thickness of about 0.01 μm to about 0.3 μm. The red photoluminescent layer may have a single-layer structure, the single-layer structure including a uniform mixture of a photoluminescent material and the inorganic pigment. The red photoluminescent layer may include the inorganic pigment in an amount of about 0.1 parts to about 5 parts by weight, based on 100 parts by weight of the photoluminescent material.

A relation of I_{590 nm}/I_{610 nm} may equal about 0.8:1 to about 1:1, I_{590 nm} being an intensity of a light emitting peak of the red photoluminescent layer at about 590 nm, and I_{610 nm} being an intensity of a light emitting peak of the red photoluminescent layer at about 610 nm. The discharge gas may include a xenon gas at a partial pressure of about 5% to about 20% of a total pressure of the discharge gas. The discharge gas may include xenon, helium, and neon, a partial pressure of the xenon gas being about 5% to about 20% of a total pressure of the discharge gas, a partial pressure of the helium gas being about 20% to about 40% of the total pressure of the discharge gas, and a partial pressure of the neon gas being about 40% to about 70% of the total pressure of the discharge gas. The plurality of photoluminescent layers may include red photoluminescent layers, blue photoluminescent layers, and green photoluminescent layers, each one of the red photoluminescent layers including the inorganic pigment.

At least one of the above and other features and advantages of the present invention may be also realized by providing a plasma display device, including a PDP, and a filter on a front surface of the PDP, the PDP having a first substrate spaced apart from a second substrate by a predetermined distance, a plurality of display electrodes along a first direction between the first and second substrates, a plurality of address electrodes along a second direction between the first and second substrates, the second direction crossing the first direction, a plurality of barrier ribs between the first and second substrates to define discharge cells, at least one dielectric layer between the display and address electrodes, a protective layer on the dielectric layer, a discharge gas in the discharge cells, and a plurality of photoluminescent layers in the discharge cells, the photoluminescent layers including at least one red photoluminescent layer, the red photoluminescent layer including at least one inorganic pigment and exhibiting a substantially larger decrease in a light emitting peak at about 570 nm to about 600 nm than at about 610 to about 630 nm, as compared to a comparable photoluminescent layer including no inorganic pigment. The filter may include no neon-cut shield layer.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial exploded perspective view of a PDP according to an embodiment of the present invention;

FIG. 2 illustrates an exploded perspective view of a plasma display device including the PDP of FIG. 1;

FIG. 3 illustrates a cross-sectional view of a front filter in the plasma display device of FIG. 2; and

FIG. 4 illustrates light emission spectra of PDPs of Example 1 and Comparative Example 1.

### DETAILED DESCRIPTION OF THE INVENTION

Korean Patent Application No. 10-2007-0026162, filed on Mar. 16, 2007, in the Korean Intellectual Property Office, and entitled: “PDP,” is incorporated by reference herein in is entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers, elements, and regions may be exaggerated for clarity of illustration. It will also be understood that when a layer or element is referred to as being “on” another layer, element, or substrate, it can be directly on the other layer, element, or substrate, or intervening layers and/or elements may also be present. Further, it will also be understood that when a layer or element is referred to as being “between” two layers or elements, it can be the only layer or element between the two layers or elements, or one or more intervening layers and/or elements may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the terms “a” and “an” are open terms that may be used in conjunction with singular items or with plural items. For example, the term “an inorganic pigment” may represent a single compound, e.g., iron oxide, or multiple compounds in combination, e.g., iron oxide mixed with cuprous oxide.

According to an embodiment of the present invention, red color purity of an image displayed on a screen of a PDP may be increased by coloring red photoluminescent layers of the PDP with a red color to absorb orange light emitted at a wavelength of about 570 nm to about 600 nm and by providing a discharge gas at a specific predetermined mixing ratio.

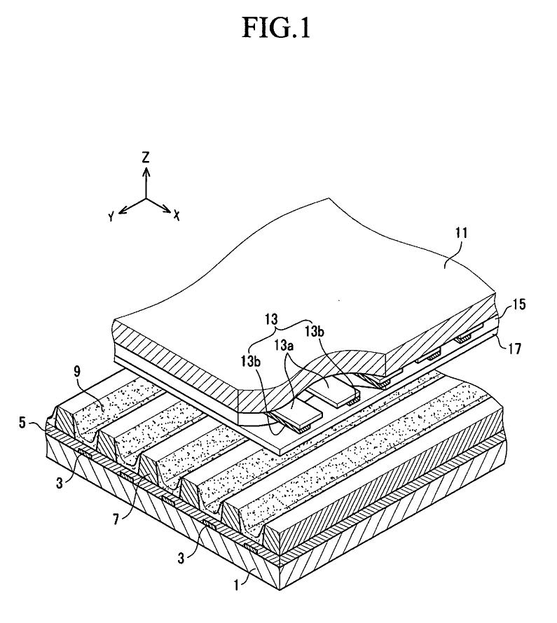

FIG. 1 illustrates an exemplary PDP according to an embodiment of the present invention. Referring to FIG. 1, the PDP may include a first substrate 1, e.g., a rear substrate, a second substrate 11, e.g., a front substrate including a screen, parallel to the first substrate 1, address electrodes 3, barrier ribs 7, display electrodes 13, and photoluminescent layers 9.

The address electrodes 3 may be parallel to each other, and may be disposed along a first direction, e.g., along the y-axis, on the first substrate 1. A first dielectric layer 5 may be disposed to cover the address electrodes 3, such that the address electrodes 3 may be between the first substrate 1 and the first dielectric layer 5. The barrier ribs 7 may be formed to a predetermined height on the first dielectric layer 5 to define discharge cells of any suitable shape. For example, as illustrated in FIG. 1, each discharge cell may extend along the first direction between two barrier ribs 7, and may correspond to one address electrode 3. The discharge cells may be formed at intersection points of the address electrodes 3 and the display electrodes 13. The photoluminescent layers 9 may be disposed in the discharge cells.

The display electrodes 13 may include sustain electrodes, i.e., X electrodes, and scan electrodes, i.e., Y electrodes, in an alternating pattern. The display electrodes 13 may include pairs of transparent and bus electrodes 13a and 13b along a second direction, e.g., along the x-axis, on the second substrate 1, so each electrode of the sustain and scan electrodes may include a pair of the transparent and bus electrodes 13a and 13b. The display electrodes 13 may face the first substrate 1, and may cross the address electrodes 3. A second dielectric layer 15, e.g., formed by a printing process, may be disposed on the second substrate 11 to face the first substrate 1, such that the display electrodes 13 may be between the second substrate 11 and the second dielectric layer 15. The second dielectric layer 15 may be substantially similar to the first dielectric layer 5. A protective layer 17 may be on the second dielectric layer 15 to face the first substrate 1.

In the above-described PDP, address discharge may be performed by applying an address voltage (Va) to a space between the address electrodes 3 and any one of the sustain electrodes of the display electrodes 13. Once address discharge is generated in selected discharge cells, i.e., discharge cells to be operated, a sustain voltage (Vs) may be applied to a space between a pair of display electrodes 13 corresponding to the selected discharge cells. The sustain voltage may trigger UV light in the discharge cells, so photoluminescent layers 9 in corresponding discharge cells may emit light toward the second substrate 11 to form an image on the screen thereof.

The photoluminescent layers 9 may be disposed in the discharge cells, e.g., on surfaces of the barrier ribs 7, and discharge gas may be filled in the discharge cells. The photoluminescent layers 9 may include, e.g., red (R), green (G), and blue (B) phosphor layers, to emit R, G, and B lights, respectively. Photoluminescent layers 9 emitting blue and green lights may include any suitable photoluminescent materials capable of emitting blue and green lights, respectively. Photoluminescent layers 9 emitting red light may include at least one red photoluminescent material emitting red light, e.g., at least one of (Y,Gd)BO₃:Eu, YBO₃:Eu, and/or GdBO₃:Eu, and at least one inorganic pigment capable of absorbing light having a wavelength of about 570 nm to about 600 nm, e.g., iron oxide (Fe₂O₃), cupric oxide (CuO), and/or cuprous oxide (Cu₂O). Accordingly, red light emitted from the photoluminescent layers 9 may have color coordinates exhibiting improved red color purity. More specifically, red light emitted from the photoluminescent layers 9 may have a x color coordinate of about 0.660 to about 0.670 and a y color coordinate of about 0.322 to about 0.330. Hereinafter, “photoluminescent layers 9 emitting red light” may be referred to as “red photoluminescent layers,” and may be used interchangeably therewith.

More specifically, the inorganic pigment in the red photoluminescent layers may have an average particle diameter smaller than about 0.3 μm. For example, the inorganic pigment may have an average particle diameter of about 0.01 μm to about 0.3 μm. When the average particle diameter of the inorganic pigment exceeds about 0.3 μm, brightness of the emitted light may decrease, and light emission characteristics of the red photoluminescent material may be reduced. Reduced brightness and light emission characteristics of the red photoluminescent material may cause difficulties in using the inorganic pigment in the PDP.

The red photoluminescent material and the inorganic pigment may be mixed to form a uniform mixture, so the red photoluminescent layers may have a single-layer structure including both the red photoluminescent material and the inorganic pigment in the single layer. Alternatively, the inorganic pigment may be coated on the red photoluminescent material, so the red photoluminescent layers may have a multi-layer structure including at least one layer of the red photoluminescent material and at least one layer of the inorganic pigment in each one of the red photoluminescent layers. Relative amounts of the red photoluminescent material and the inorganic pigment, either in the single-layer structure or in the multi-layer structure, may be controlled to maximize light emission efficiency of the red photoluminescent material, while providing sufficient absorption of orange light.

If the red photoluminescent material is coated with the inorganic pigment, a thickness of the inorganic pigment on the red photoluminescent material may be about 0.01 μm to about 0.3 μm. When the thickness of the inorganic pigment on the red photoluminescent material is less than about 0.01 μm, orange light may be absorbed insufficiently, so red color purity may not be significantly improved. When the thickness of the inorganic pigment on the red photoluminescent material is greater than about 0.3 μm, a relative ratio of the red photoluminescent material to the inorganic pigment in the red photoluminescent layer may be reduced, so red light emission efficiency may be deteriorated.

If the red photoluminescent material is mixed with the inorganic pigment to form a uniform mixture, an amount of the inorganic pigment in the red photoluminescent layer may be about 0.1 parts to about 5 parts by weight, based on 100 parts by weight of the red photoluminescent material in the red photoluminescent layer. When the amount of the inorganic pigment is lower than about 0.1 parts by weight, orange light may be absorbed insufficiently, so red color purity may not be significantly improved. When the amount of the inorganic pigment is higher than about 5 parts by weight, the relative amount of the red photoluminescent material in the red photoluminescent layer may be reduced, so red light emission efficiency may be deteriorated.

Use of the inorganic pigment in the red photoluminescent layers according to embodiments of the present invention may be advantageous in substantially reducing orange light emission at a wavelength of about 570 nm to about 600 nm, while light emission at other wavelengths, e.g., red light emission at a wavelength of about 610 nm to about 630 nm, may have a negligible effect. For example, the red photoluminescent layers according to embodiments of the present invention may exhibit a substantially reduced light emission peak solely at about 590 nm, i.e., so changes of light emission at other wavelengths may be negligible as compared to the reduced light emission peak at about 590 nm. As a result, when compared to a comparable photoluminescent layer including no inorganic pigment, a decrease of the light emission of the red photoluminescent layers at about 570 nm to about 600 nm may be substantially larger than a decrease of the light emission at about 610 nm to about 630. More specifically, the light emission of the red photoluminescent layers may satisfy Equation 1 below,

|L_{P}−L_{P+1}|_{570-600 nm}≧2|L_{P}−L_{P+1}|_{610-630 nm} Equation 1

where L_{P} denotes light emitting peak of the comparable photoluminescent layer without the inorganic pigment, L_{P+1} denotes a light emitting peak of the red photoluminescent layer, and the subscripts 570-600 nm and 610-630 nm denote wavelength ranges. In it noted that a “comparable photoluminescent layer” refers to a photoluminescent layer formed of substantially same materials via a substantially same method to have a substantially same structure as the red photoluminescent layer.

In particular, the red photoluminescent material may have main light emission peaks at about 590 nm, at about 610 nm, and at about 630 nm. When the inorganic pigment is not used, light intensity of the red photoluminescent material at a range of about 570 nm to about 600 nm, i.e., peak of about 590 nm, may be higher than light emission peaks at about 610 nm and at about 630 nm. More specifically, the ratio I_{590 nm/}I_{610-630 nm} in the comparable red photoluminescent layer including no inorganic pigment may be about 1.4:1 to about 1.6:1, where I_{590 nm} denotes light intensity of light emitted at about 590 nm, and I_{610-630 nm} denotes an average light intensity of light emitted at about 610 nm to about 630 nm. When the inorganic pigment is added to the red photoluminescent material to form the photoluminescent layers 9 emitting red light according to embodiments of the present invention, the light emission peak at about 590 nm, i.e., emission range of orange light, may be reduced by about 10% to about 30%, e.g., 20±5%, and an average light intensity of light emitted at about 610 nm to about 630 nm may be reduced by about 2% to about 3%. Thus, orange light emission at a range of about 570 nm to about 600 nm may be reduced by a substantially larger amount than the red light emission at a wavelength range of about 610 nm to about 630. Accordingly, when the inorganic pigment is used, the ratio I_{590 nm}/I_{610-630 nm} in the red photoluminescent layers may be about 0.8:1 to about 1:1. It is noted that the range of about 570 nm to about 600 nm may include a light emitting peak of about 590 nm, and the range of about 610 nm to about 630 nm may include an average peak of the peaks at about 610 nm and at about 630 nm.

As seen from the above, adding the inorganic pigment to the red photoluminescent material to form the red photoluminescent layers according to embodiments of the present invention may substantially modify the ratio I_{590 nm}I_{610-630 nm.} Accordingly, emission of orange light, i.e., light emitted at a wavelength range having a light emitting wavelength peak at about 590 nm, may be substantially reduced, while emission of red light at a wavelength of about 610 nm to about 630 nm, may be only negligibly reduced. As such, emission of orange light may be substantially minimized, so red light emission efficiency and red color purity may be substantially improved.

The red photoluminescent layers according to embodiments of the present invention may be formed, e.g., by using a photolithography method, a screen printing method, or a method of setting up a film formed of mixed phosphor particles. If the method of setting up a film formed of mixed phosphor particles is used, the red photoluminescent material may be mixed with the inorganic pigment at a predetermined ratio to form a mixture, followed by dispersion of the mixture in a vehicle including a binder resin and a solvent to form a uniform dispersion. Next, for example, the uniform dispersion may be coated on the first substrate 1 and baked at about 300° C. to about 500° C. for about 1 hour to about 5 hours.

The binder resin of the vehicle may be, e.g., a cellulose-based resin, and the solvent may be, e.g., an organic solvent. Examples of a cellulose-based resin may include one or more of ethylcellulose and/or an acryl resin. Examples of the organic solvent may include one or more of hexanetriol, polypropylene glycol, butyl carbitol acetate, and/or terpineol.

The discharge cells of the PDP may include a discharge gas therein. The discharge gas may include, e.g., one or more of xenon (Xe), helium (He), and/or neon (Ne). A predetermined mixing ratio of the discharge gas may affect color of the discharge gas and the discharge brightness, so the mixing ratio of the discharge gas may affect electrical/optical parameters of the PDP, e.g., red color purity. For example, a colorless discharge gas with low discharge brightness may not affect color realization of the photoluminescent layers 9, so color purity of light emitted from the red photoluminescent layers may be improved. Accordingly, the PDP according to embodiments of the present invention may include the red photoluminescent layers and a predetermined mixing ratio of the discharge gas to minimize emission of orange light from the red photoluminescent material and improve red color purity.

More specifically, the predetermined mixing ratio of the discharge gas may include Xe at a partial pressure of about 5% to about 20% of the total discharge gas, e.g., about 10 to 15%, He at a partial pressure of about 20% to about 40% of the total discharge gas, and Ne at a partial pressure of about 40% to about 70% of the total discharge gas. For example, the discharge gas may include Xe at a partial pressure of about 15%, He at a partial pressure of about 35%, and Ne at a partial pressure of about 50%.

Use of the discharge gas at the predetermined mixing ratio may decrease discharge delay time during the PDP operation, and may improve color purity thereof. When partial pressures of the discharge gas are not within the specified ranges, discharge delay time may be increased and color purity may be reduced. It is noted that discharge brightness of the PDP may be determined based on properties of the ultraviolet (UV) light generated by the discharge gas. For example, longer wavelengths of the UV light may increase discharge brightness.

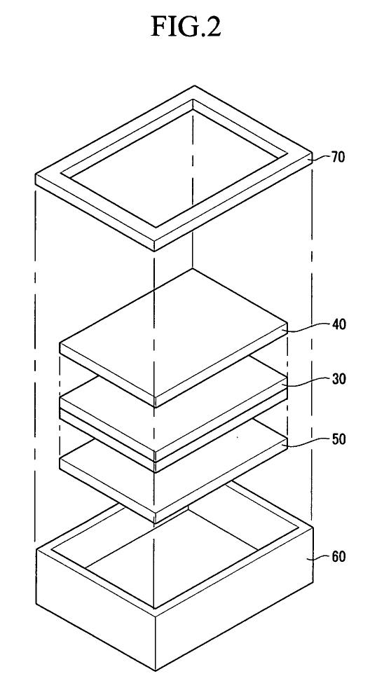

When a PDP includes the photoluminescent layers 9 and discharge gas according to embodiments of the present invention, a plasma display device may not require use of a neon-cut shield layer in a front filter thereon. For example, as illustrated in FIG. 2, a plasma display device may include a PDP 30, a printed circuit board (PCB) 50, and a front filter 40 directly attached to the PDP 30. If the front filter 40 is a glass-type front filter, the plasma display device may further include a case 60 and a cover 70. The PCB 50 may be placed in the case 60. As illustrated in FIG. 2, the cover 70 may enclose peripheral portions of the front filter 40, and may be connected to the case 60, so the front filter 40, the PDP 30, and the PCB 50 may be positioned between the case 60 and the cover 70.

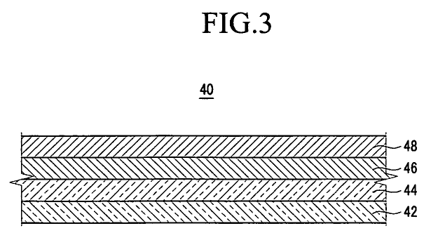

The PDP 30 may be the PDP described previously with reference to FIG. 1. The second substrate 11 may be the front substrate, and may be attached, e.g., laminated, to the first substrate 1. Accordingly, the filter 40, as will be described in more detail below with reference to FIG. 3, may be on the second substrate 11. The PCB 50 may be on a rear surface of the first substrate 1 of the PDP 30, and may include a plurality of driving and controlling circuits (not shown) for driving the display and address electrodes 13 and 3 (illustrated in FIG. 1) of the PDP 30. A heat dissipating plate (not shown) may be between the PCB 50 and the PDP 30 to dissipate heat from the PDP 30 and from the PCB 50.

In the plasma display device, a direct current (DC) voltage or an alternating current (AC) voltage may be applied to the electrodes of the PDP 30 according to a predetermined electrical signal generated in the PCB 50, so discharge may be generated in the discharge gas between the substrates of the PDP 30. The discharge may cause generation of UV light to excite the photoluminescent layers to emit light.

FIG. 3 illustrates an exemplary cross-sectional view of the front filter 40. The front filter 40 of the plasma display device may shield electromagnetic waves and near infrared light generated during the discharge. In particular, the front filter 40 may shield the electromagnetic waves, may absorb the near infrared light, and may prevent or substantially minimize reflection of external light to improve color purity of the PDP 30.

Referring to FIG. 3, the front filter 40 may include a substrate 42 and a plurality of functional layers, i.e., a near infrared light absorption layer 44, an electromagnetic wave shield layer 46, and an external light reflection barrier layer 48. Each of the functional layers may be deleted or added if necessary. Further, the functional layers may be arranged on the substrate 42 in any suitable configuration. For example, the near infrared light absorption layer 44, the electromagnetic wave shield layer 46, and the external light reflection barrier layer 48 may be sequentially stacked on the substrate 42 as separate layers. In another example, any two or three layers of the near infrared light absorption layer 44, the electromagnetic wave shield layer 46, and the external light reflection barrier layer 48 may be integrated into a single layer having a combination of the respective functions. Adhesive layers (not shown) may be disposed between the functional layers. The front filter 40 may be formed, e.g., by preparing a composition for each of the functional layers, and by sequentially coating the substrate 42 with each of the compositions and drying it. The coating method may include, e.g., spray coating, roll coating, bar coating, spin coating, and so forth.

The substrate 42 of the front filter 40 may support the functional layers, may be transparent, e.g., may have a visible light emission peak of over 80%, and may be heat resistant, e.g., have a glass transition temperature higher than about 60° C. The substrate 42 may be formed of, e.g., glass or a plastic. Examples of glass may include tempered glass or half-tempered glass including glass or quartz. Examples of the plastic may include a transparent polymer, e.g., an acryl-based polymer, polycarbonate-based polymers, polyethyleneterephthalate (PET), polyethersulfone (PES), poly sulfone (PS), polystyrene, polyethylene naphthalate, polyarylate, polyetheretherketone (PEEK), polycarbonate (PC), polypropylene (PP), polyimide, triacetylcellulose (TAC), and polymethylmethacrylate (PMMA). PET, for example, may have a relatively low price with respect to its heat resistance and transparency properties. The substrate 42 may be omitted, when the front filter 40 is directly attached to the second substrate 11 of the PDP 30.

The near infrared light absorption layer 44 of the front filter 40 may absorb near infrared light generated in the PDP 30, e.g., wavelengths of about 800 nm to about 1000 nm, during discharge, so emission of the near infrared light out of the PDP 30 may be prevented or substantially minimized. Accordingly, signals transmitted via near infrared light, e.g., remote control signals, may be transmitted without interruption. The near infrared absorption layer 44 may include a dye to absorb the near infrared light. Examples of the dye may include one or more of di-ammonium salt, quinone, a metal complex, phthalocyanine, naphthalocyanine, polymethine-based materials, and/or cyanine-based materials.

The electromagnetic wave shield layer 46 of the front filter 40 may absorb electromagnetic waves generated in the PDP 30 during discharge, so emission of electromagnetic waves out of the PDP 30 may be prevented or substantially minimized. The electromagnetic wave shield layer 46 may be formed as a conductive mesh, a transparent conductive layer, or a structure having a conductive mesh on a transparent conductive layer. The electromagnetic wave shield layer 46 may be grounded to a ground power source through a conductive case (not shown) to discharge the absorbed electromagnetic waves to the ground power source.

The external light reflection barrier layer 48 of the front filter 40 may be disposed in an outermost part of the front filter 40, and may absorb external light incident on the front filter 40. Accordingly, the external light may not be reflected away from the front filter 40 toward the outside. The external light reflection barrier layer 48 may undergo an anti-smudge treatment, so an outer surface thereof, i.e., an outer surface of the front filter 40, may be prevented or substantially minimized from being contaminated by, e.g., user contact.

### EXAMPLES

### Example 1

A composition for forming a red phosphor layer was prepared to include 41 wt % of (Y,Gd)BO₃:Eu coated with Fe₂O₃, 4.6 wt % of ethyl cellulose as a binder, and 54.4 wt % of solvent. The average particle diameter of the Fe₂O₃ was 0.15 μm, and a weight ratio of the (Y,Gd)BO₃:Eu to the Fe₂O₃ in the composition was 100:0.1. The solvent was prepared by mixing butyl carbitol acetate and terpineol at a weight ratio of 3:7.

Next, the composition for forming the red phosphor layer was printed on a substrate, followed by baking. The blue and green phosphor layers were formed by substantially same methods as the red phosphor layer, with the exception of using BaMgAl₁₀O₁₇:Eu and ZnSiO₄:Mn, respectively, as the photoluminescent materials. No inorganic pigments were used in the blue and green phosphor layers.

A PDP was manufactured by attaching display electrodes having a stripe pattern to a front substrate formed of soda lime glass. Subsequently, a dielectric layer of lead glass paste was coated on an entire surface of the front substrate, followed by baking. The dielectric layer was applied to the display electrodes. Next, address electrodes were attached to a rear substrate, followed by formation of a dielectric layer and barrier ribs thereon. The red, blue, and green phosphor layers were applied to the rear substrate and to the barrier ribs, followed by attaching and sealing the two substrates. Subsequently, air was exhausted out of a space between the sealed substrates, followed by injecting a discharge gas and aging the assembled PDP. The discharge gas mixture was prepared to have a pressure of 200 Torr, i.e., partial pressure of Xe being 15% of the total pressure, partial pressure of He being 35% of the total pressure, and partial pressure of Ne being 50% of the total pressure.

### Example 2

a PDP was manufactured according to the same method as Example 1, with the exception of mixing Fe₂O₃ with (Y,Gd)BO₃:Eu, instead of coating. The (Y,Gd)BO₃:Eu was used in an amount of 40 wt % of the total composition, Fe₂O₃ was used in an amount of 1 wt % of the total composition. Relative amounts of binder and solvent were the same as in Example 1.

### Comparative Example 1

a PDP was manufactured according to the same method as in Example 1, with the exception that no inorganic pigment was used in preparation of the red phosphor composition.

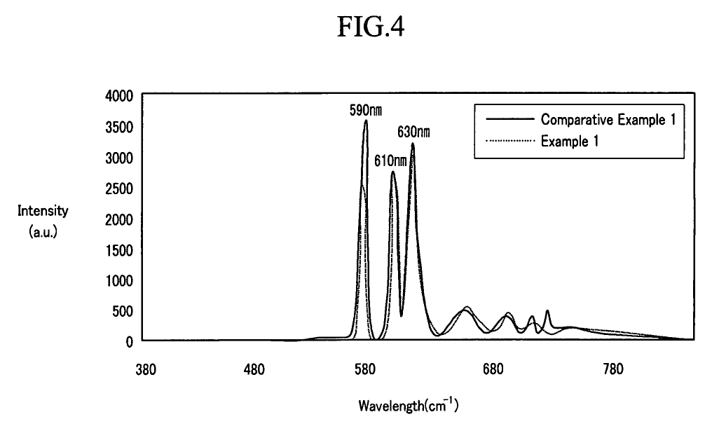

The PDPs of Example 1 and Comparative Example 1 were evaluated in terms of red light emission. FIG. 4 illustrates light emission spectra of the PDPs manufactured according to Example 1 and Comparative Example 1.

As shown in FIG. 4, the light emission peak of the PDP manufactured according to Example 1, i.e., the PDP including inorganic pigment in the red phosphor layer, at about 590 nm was substantially lower than the light emission peak of the PDP of the Comparative Example 1, i.e., the PDP including no inorganic pigment, at about 590 nm. In particular, the light emission peak of the PDP of Example 1 was lower by about 1000 au than the light emission peak of the PDP of Comparative Example 1 at about 590 nm. As further shown in FIG. 4, the light emission peaks of the PDPs of Example 1 and Comparative Example 1 were substantially the same at about 610 nm and at about 630 nm.

Embodiments of a PDP according to the present invention may be advantageous in providing photoluminescent layers emitting red light and having improved red color purity. In particular, the photoluminescent layers emitting red light may include an inorganic pigment, so orange light emitted at about 570 nm to about 600 nm and having a light emitting peak at about 590 nm may be effectively absorbed. Therefore, the PDP may realize red color with excellent color purity without using a neon-cut shield layer in the front filter thereof.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate spaced apart from a second substrate by a predetermined distance;
a plurality of display electrodes along a first direction between the first and second substrates;
a plurality of address electrodes along a second direction between the first and second substrates, the second direction crossing the first direction;
a plurality of barrier ribs between the first and second substrates to define discharge cells;
at least one dielectric layer between the display and address electrodes;
a protective layer on the dielectric layer;
a discharge gas in the discharge cells; and
a plurality of photoluminescent layers in the discharge cells, the photoluminescent layers including at least one red photoluminescent layer, the red photoluminescent layer including at least one inorganic pigment and exhibiting a substantially larger decrease in a light emitting peak at about 570 nm to about 600 nm than at about 610 to about 630 nm, as compared to a comparable photoluminescent layer including no inorganic pigment.

2. The PDP as claimed in claim 1, wherein the light emitting peaks at about 570 nm to about 600 nm and at about 610 nm to about 630 nm of the red photoluminescent layer relate to corresponding light emitting peaks of the comparable photoluminescent layer including no inorganic pigment according to Equation 1 below,

|L_{P}−L_{P+1}|_{570-600 nm}≧2|L_{P}−L_{P+1}|_{610-630 nm} Equation 1
where L_{P} denotes a light emitting peak of the comparable photoluminescent layer without the inorganic pigment, L_{P+1} denotes a light emitting peak of the red photoluminescent layer, and the subscripts 570-600 nm and 610-630 nm denote wavelength ranges.

3. The PDP as claimed in claim 1, wherein the red photoluminescent layer includes at least one of (Y,Gd)BO₃:Eu, YBO₃:Eu, and GdBO₃:Eu.

4. The PDP as claimed in claim 1, wherein the inorganic pigment includes at least one of Fe₂O₃, CuO, and Cu₂O.

5. The PDP as claimed in claim 1, wherein the red photoluminescent layer has a single-layer structure or a multi-layer structure.

6. The PDP as claimed in claim 5, wherein the red photoluminescent layer has a multi-layer structure, the multi-layer structure including at least one photoluminescent material layer and at least one inorganic pigment layer on the photoluminescent material layer.

7. The PDP as claimed in claim 6, wherein the inorganic pigment layer has a thickness of about 0.01 μm to about 0.3 μm.

8. The PDP as claimed in claim 5, wherein the red photoluminescent layer has a single-layer structure, the single-layer structure including a uniform mixture of a photoluminescent material and the inorganic pigment.

9. The PDP as claimed in claim 8, wherein the red photoluminescent layer includes the inorganic pigment in an amount of about 0.1 parts to about 5 parts by weight, based on 100 parts by weight of the photoluminescent material.

10. The PDP as claimed in claim 1, wherein a relation of I_{590 nm}/I_{610 nm} equals about 0.8:1 to about 1:1, I_{590 nm} being an intensity of a light emitting peak of the red photoluminescent layer at about 590 nm, and I_{610 nm} being an intensity of a light emitting peak of the red photoluminescent layer at about 610 nm.

11. The PDP as claimed in claim 1, wherein the discharge gas includes a xenon gas at a partial pressure of about 5% to about 20% of a total pressure of the discharge gas.

12. The PDP as claimed in claim 1, wherein the discharge gas includes xenon, helium, and neon, a partial pressure of the xenon gas being about 5% to about 20% of a total pressure of the discharge gas, a partial pressure of the helium gas being about 20% to about 40% of the total pressure of the discharge gas, and a partial pressure of the neon gas being about 40% to about 70% of the total pressure of the discharge gas.

13. The PDP as claimed in claim 1, wherein the plurality of photoluminescent layers includes red photoluminescent layers, blue photoluminescent layers, and green photoluminescent layers, each one of the red photoluminescent layers including the inorganic pigment.

14. A plasma display device, comprising:
a plasma display panel (PDP); and
a filter on a front surface of the PDP, the PDP including,
a first substrate spaced apart from a second substrate by a predetermined distance;
a plurality of display electrodes along a first direction between the first and second substrates;
a plurality of address electrodes along a second direction between the first and second substrates, the second direction crossing the first direction;
a plurality of barrier ribs between the first and second substrates to define discharge cells;
at least one dielectric layer between the display and address electrodes;
a protective layer on the dielectric layer;
a discharge gas in the discharge cells; and
a plurality of photoluminescent layers in the discharge cells, the photoluminescent layers including at least one red photoluminescent layer, the red photoluminescent layer including at least one inorganic pigment and exhibiting a substantially larger decrease in a light emitting peak at about 570 nm to about 600 nm than at about 610 to about 630 nm, as compared to a comparable photoluminescent layer including no inorganic pigment.

15. The plasma display device as claimed in claim 14, wherein the filter includes no neon-cut shield layer.
